(19) United States
(12) Patent Application Publication
(10) Pub. No.: US 2025/0164777 A1
(43) Pub. Date: May 22, 2025

(54) OPTICAL SCANNING SYSTEM

(71) Applicant: NALUX CO., LTD., Osaka (JP)

(72) Inventors: Hideki NISHIOKA, Osaka (JP); Tomohito KUWAGAITO, Osaka (JP); Jumpei ODA, Osaka (JP)

(73) Assignee: NALUX CO., LTD., Osaka (JP)

(21) Appl. No.: 18/927,142

(22) Filed: Oct. 25, 2024

Related U.S. Application Data
(63) Continuation of application No. PCT/JP2023/041977, filed on Nov. 22, 2023.

(51) Int. Cl. G02B 26/08

(52) U.S. Cl. CPC G02B 26/0816

(57) ABSTRACT

An optical scanning system comprising a deflector, collimator lenses arranged in a line in the direction of the rotation axis of the deflector, a first lens, a second lens and an imaging optical system, wherein in both lens surfaces of the first lens and one lens surface of the second lens, the shape in a horizontal first cross section and the shape in a vertical second cross section is different from each other, in the first lens, a surface facing the second lens is shaped in the first cross section to diverge a light beam, a surface facing the collimator lenses is shaped in the second cross section to converge a light beam and a surface of the second lens is shaped in the first cross section to collimate or converge a light beam.

### CROSS REFERENCE TO RELATED APPLICATION

This is a Continuation of International Patent Application No. PCT/JP2023/041977 filed Nov. 22, 2023, which designates the U.S. The contents of this application are hereby incorporated by reference.

### TECHNICAL FIELD

The present invention relates to an optical scanning system.

### BACKGROUND ART

Optical scanning systems that include an optical system for receiving light, a deflector and an imaging optical system, wherein the optical system for receiving light includes plural collimator lenses arranged in a line in the direction of the rotation axis of the deflector so as to receive light beams from plural light sources arranged in a line in the direction of the rotation axis of the deflector, are used. Further, in order to enhance the speed of printing, optical scanning systems that employ an overfilling method in which a light beam, a width of which is greater than a length of a side face of the deflector in a horizontal plane is made to enter he deflector, have also been developed (Patent document 1, for example).

In order to make such optical scanning systems compact, a lateral magnification of the imaging optical system in a cross section parallel to the rotation axis of the deflector must be made smaller than a predetermined value. In order to ensure a diameter of a light beam for scanning with the lateral magnification smaller than the predetermined value, a focal length of each of the collimator lenses should be reduced. On the other hand, when the focal length of each of the collimator lenses is reduced, a width of a light beam in a cross section perpendicular to the rotation axis of the deflector is also reduced. As a result, the size of the optical system for receiving light must be made greater in order to enlarge the width of the light beam.

In short, a compact optical scanning system that is configured to receive light beams from plural light sources arranged in a line in the direction of the rotation axis of the deflector and employs an overfilling method has not been developed. Accordingly, there is a need for a compact optical scanning system that is configured to receive light beams from plural light sources arranged in a line in the direction of the rotation axis of the deflector and employs an overfilling method.

### PRIOR ART DOCUMENT

### Patent Document

Patent document 1: JP2010061144 (A)

The object of the present invention is to provide a compact optical scanning system that is configured to receive light beams from plural light sources arranged in a line in the direction of the rotation axis of the deflector and employs an overfilling method.

### SUMMARY OF THE INVENTION

An optical scanning system according to a first aspect of the present invention includes a deflector, collimator lenses arranged in a line in the direction of the rotation axis of the deflector, a first lens, a second lens and an imaging optical system. The optical scanning system is configured such that a light beam that has passed through one of the collimator lenses, the first lens and the second lens and is deflected by the deflector is converged by the imaging optical system such that the light beam serves as a beam for scanning. When a cross section that is perpendicular to the rotation axis and contains a common optical axis of the first lens and the second lens is referred to a first cross section and a cross section that is parallel to the rotation axis and contains the optical axis is referred to a second cross section, in both lens surfaces of the first lens and one lens surface of the second lens, the shape in the first cross section and the shape in the second cross section is different from each other, a surface facing the second lens of the first lens is shaped in the first cross section to diverge a light beam, a surface facing the collimator lenses of the first lens is shaped in the second cross section to converge a light beam and a surface of the second lens is shaped in the first cross section to collimate or converge a light beam. The optical scanning system is configured such that a width of a light beam that has reached a side face of the deflector is greater than a length of the side face in the first cross section and the light beam is focused on the side face in the second cross section.

By the use of the first lens and the second lens having features described above, a compact optical scanning system that is configured to receive light beams from plural light sources arranged in a line in the direction of the rotation axis of the deflector and employs an overfilling method can be realized.

Since a light beam is diverged in the first cross section by the surface facing the second lens of the first lens, influence on paths of rays of a change in refractive index and the like caused by a change in temperature can be reduced.

In the optical scanning system according to an embodiment of the first aspect of the present invention, both surfaces of the first lens and one surface of the second surface is cylindrical or toric.

In the optical scanning system according to another embodiment of the first aspect of the present invention, material of the first lens is plastic and the material of the second lens is glass.

Since the second lens is located near the deflector, temperature of which rises during operation, glass is used as material of the second lens. Concerning glass, a change in refractive index and a change in a coefficient of linear thermal expansion caused by a change in temperature is relatively small.

In the optical scanning system according to another embodiment of the first aspect of the present invention, when a value of focal length of each of the collimator lenses is represented by fcol [mm], an absolute value of focal length in the first cross section of the first lens is represented by f11 [mm], an absolute value of focal length in the second cross section of the first lens is represented by f12 [mm] and an absolute value of focal length in the first cross section of the second lens is represented by f21 [mm], the following expressions are satisfied.

$$fcol ≦ 13 \qquad ( 1 )$$

$$120 ≦ f 12 ≦ 160 \qquad ( 2 )$$

$$3.5 ≦ f 21 / f 11 ≦ 4. \qquad ( 3 )$$

In order to make an optical scanning system that is configured to receive light beams from plural light sources arranged in a line in the direction of the rotation axis of the deflector, a lateral magnification of the imaging optical system in a cross section parallel to the rotation axis of the deflector must be restricted. When the lateral magnification of the imaging optical system is restricted, a diameter of the aperture in the second cross section must be reduced in order to obtain a predetermined diameter of a beam for scanning. Accordingly, the value of focal length fco of each collimator lens must be less than a predetermined value in order to maintain efficiency of light. Further, the absolute value of focal length f12 in the second cross section of the first lens should preferably be less than a predetermined value from the standpoint of a distance between the first lens and the deflector and should preferably be greater than a predetermined value from the standpoint of the size of the imaging optical system in the direction of the rotation axis of the deflector. Further, when a ratio of the absolute value of focal length f21 in the first cross section of the second lens to the absolute value of focal length f11 in the first cross section of the first lens is in a range appropriately determined, it is possible to illuminate a deflector of an appropriate size with a light beam with an appropriate width.

In the optical scanning system according to another embodiment of the first aspect of the present invention, when a first straight line that is a projection of a path of the principal ray of a deflected light beam onto a plane perpendicular to the rotation axis of the deflector is perpendicular to a second straight line that is a projection of the scanning direction onto the plane, a point at which the principal ray is reflected on the deflector is referred to as a reference point, a distance between the reference point and a scanning plane on which a beam for scanning is focused and which is perpendicular to the first straight line is represented by L8, a distance between the vertex of a lens surface that is closest to the scanning plane and the scanning plane is represented by BF, a plane that contains the reference point and is parallel to the rotation axis and the first straight is referred to as a third cross section, and a lateral magnification of the imaging optical system in the third cross section is represented by β, the following expressions are satisfied.

$$0.15 ≦ BF / L 8 ≦ 0.2 \qquad ( 4 )$$

$$0.35 ≦ β ≦ 0.45 \qquad ( 5 )$$

When the expressions described above are satisfied, an optical scanning system that is configured to receive light beams from plural light sources arranged in a line in the direction of the rotation axis of the deflector, can be made compact.

In the optical scanning system according to another embodiment of the first aspect of the present invention, material of the first lens is plastic and when an effective diameter of the surface facing the second lens of the first lens is represented by D11, an absolute value of focal length in the first cross section of the first lens is represented by f11, an effective diameter of the surface facing the collimator lenses of the first lens is represented by D12 and an absolute value of focal length in the second section of the first lens is represented by f12, the following expressions are satisfied.

$$0.04 ≦ D 11 / f 11 ≦ 0 \text{.07} \qquad ( 6 )$$

$$0. 7 ≦ D 12 / f 12 ≦ 0.011 \qquad ( 7 )$$

Temperature of the first lens varies greatly with time under influence of one of the light sources located nearby. According to findings of the inventors, however, when D11/f11 is equal to or less than the upper limit in Expression (6) and D12/f12 is equal to or less than the upper limit in Expression (7), deterioration in optical performance of the first lens made of plastic due to a change in refractive index and the like caused by a change in temperature is tolerable. Accordingly, the first lens that has two surfaces, in each of which the shape in the first cross section and the shape in the second cross section is different from each other, can be satisfactorily used. Although a change in refractive index due to a temperature change of a lens made of glass is less than that of a lens made of plastic, a lens made of glass that has two surfaces, in each of which the shape in the first cross section and the shape in the second cross section is different from each other, can hardly be produced and if produced, production costs would be considerable. When D11/f11 is equal to or greater than the lower limit in Expression (6) and D12/f12 is equal to or greater than the lower limit in Expression (7), a compact optical scanning system can be realized. In conclusion, by the use of the first lens made of plastic shaped such that Expressions (6) and (7) are satisfied, an optical scanning system that is compact and easy to produce can be realized.

An optical scanning system according to a second aspect of the present invention includes a deflector, collimator lenses arranged in a line in the direction of the rotation axis of the deflector, a first lens, a second lens and an imaging optical system. The optical scanning system is configured such that a light beam that has passed through one of the collimator lenses, the first lens and the second lens and is deflected by the deflector is converged by the imaging optical system such that the light beam serves as a beam for scanning. When a cross section that is perpendicular to the rotation axis and contains a common optical axis of the first lens and the second lens is referred to a first cross section and a cross section that is parallel to the rotation axis and contains the optical axis is referred to a second cross section, in both lens surfaces of the first lens and one lens surface of the second lens, the shape in the first cross section and the shape in the second cross section is different from each other, one surface of the first lens is shaped in the first cross section to diverge a light beam, the other surface of the first lens is shaped in the second cross section to converge a light beam and a surface of the second lens is shaped in the first cross section to collimate or converge a light beam. The optical scanning system is configured such that a width of a light beam that has reached a side face of the deflector is greater than a length of the side face in the first cross section and the light beam is focused on the side face in the second cross section. When a first straight line that is a projection of a path of the principal ray of a deflected light beam onto a plane perpendicular to the rotation axis of the deflector is perpendicular to a second straight line that is a projection of the scanning direction onto the plane, a point at which the principal ray is reflected on the deflector is referred to as a reference point, a distance between the reference point and a scanning plane on which a beam for scanning is focused and which is perpendicular to the first straight line is represented by L8, a distance between the vertex of a lens surface that is closest to the scanning plane and the scanning plane is represented by BF, a plane that contains the reference point and is parallel to the rotation axis and the first straight is referred to as a third cross section, and a lateral magnification of the imaging optical system in the third cross section is represented by β, the following expressions are satisfied.

$$0.15 ≦ BF / L 8 ≦ 0.2 \qquad ( 4 )$$

$$0.35 ≦ β ≦ 0.45 \qquad ( 5 )$$

An optical scanning system according to a third aspect of the present invention includes a deflector, collimator lenses arranged in a line in the direction of the rotation axis of the deflector, a first lens, a second lens and an imaging optical system. The optical scanning system is configured such that a light beam that has passed through one of the collimator lenses, the first lens and the second lens and is deflected by the deflector is converged by the imaging optical system such that the light beam serves as a beam for scanning. When a cross section that is perpendicular to the rotation axis and contains a common optical axis of the first lens and the second lens is referred to a first cross section and a cross section that is parallel to the rotation axis and contains the optical axis is referred to a second cross section, in both lens surfaces of the first lens and one lens surface of the second lens, the shape in the first cross section and the shape in the second cross section is different from each other, one surface of the first lens is shaped in the first cross section to diverge a light beam, the other surface of the first lens is shaped in the second cross section to converge a light beam and a surface of the second lens is shaped in the first cross section to collimate or converge a light beam. The optical scanning system is configured such that a width of a light beam that has reached a side face of the deflector is greater than a length of the side face in the first cross section and the light beam is focused on the side face in the second cross section. Material of the first lens is plastic and when an effective diameter of the one surface of the first lens is represented by D11, an absolute value of focal length in the first cross section of the first lens is represented by f11, an effective diameter of the other surface of the first lens is represented by D12 and an absolute value of focal length in the second section of the first lens is represented by f12, the following expressions are satisfied.

$$0.04 ≦ D 11 / f 11 ≦ 0 \text{.07} \qquad ( 6 )$$

$$0. 7 ≦ D 12 / f 12 ≦ 0.011 \qquad ( 7 )$$

### BRIEF DESCRIPTION OF DRAWINGS

FIG. 1 shows an optical scanning system according to an embodiment of the present invention;

FIG. 2 shows a cross section of the optical system for receiving light, the cross section containing the z-axis of the optical system for receiving light and being parallel to the x-axis;

FIG. 3 shows a cross section of the imaging optical system, the cross section being parallel to the x-axis and perpendicular to the y-axis;

FIG. 4 illustrates “Angle of incidence (Main)”;

FIG. 5 illustrates “Angle of incidence (Sub)”;

FIG. 6 illustrates distances L1-L8 between two surfaces shown in Table 2;

FIG. 7 illustrates “Sub-shift” of the second scanning lens in Table 2; and

FIG. 8 illustrates “Main-shift” of the second scanning lens in Table 2.

### DESCRIPTION OF EMBODIMENTS

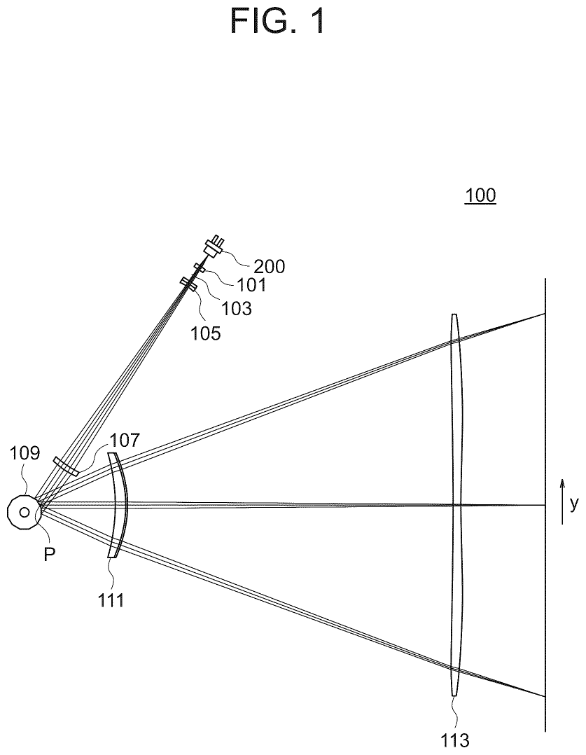

FIG. 1 shows an optical scanning system 100 according to an embodiment of the present invention. The optical scanning system 100 includes an optical system for receiving light, a deflector 109 and an imaging optical system. The system for receiving light includes a collimator lens 101, an aperture stop 103, a first lens 105 and a second lens 107. The imaging optical system includes a first scanning lens 111 and a second scanning lens 113. A light beam emitted by one of the light sources 200 is collimated by the collimator lens 101, passes through the aperture stop 103 and then reaches the first lens 105. The first lens 105 diverges the light beam in the cross section shown in FIG. 1. The light beam that has passed through the first lens 105 reaches the second lens 107. The second lens 107 changes the light beam to a collimated beam or a divergent beam in the cross section shown in FIG. 1. The light beam that has passed through the second lens 107 reaches the deflector 109. The deflector 109 deflects the light beam by rotating around a rotation axis that is perpendicular to the cross section shown in FIG. 1. The deflected light beam is converged by the first scanning lens 111 and the second scanning lens 113 such that the light beam serves as a beam for scanning.

An x-axis is defined to be in the direction of the rotation axis of the deflector 109 and a y-axis is defined to be in the scanning direction. A z-axis of the optical system for receiving light is defined to agree with the common optical axis (central axis) of the first lens 105 and the second lens 107. FIG. 1 shows the cross section that is perpendicular to the x-axis and contains the z-axis of the optical system for receiving light.

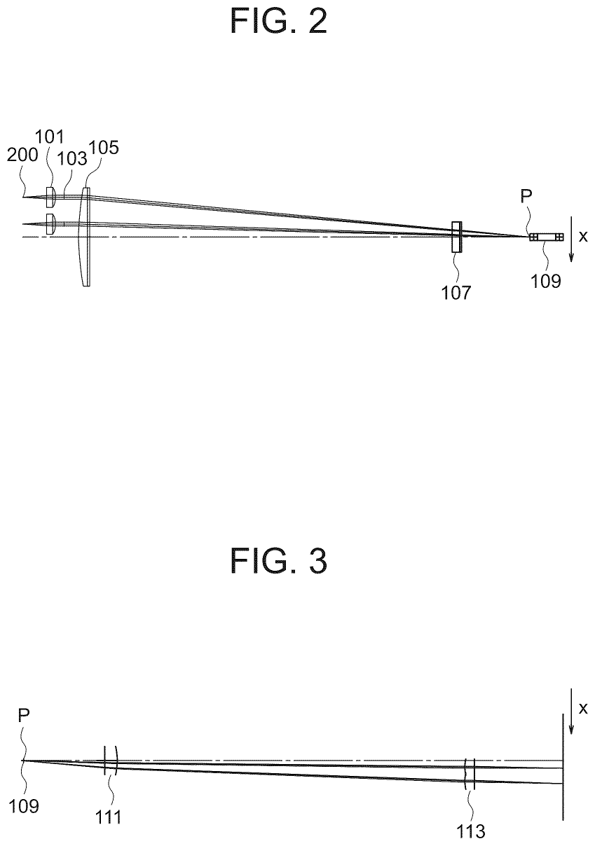

FIG. 2 shows a cross section of the optical system for receiving light, the cross section containing the z-axis of the optical system for receiving light and being parallel to the x-axis. In the cross section shown in FIG. 2, a light beam emitted by one of the light sources 200 arranged in a line in the direction of the rotation axis of the deflector 109 is collimated by one of collimator lenses 101 arranged in a line in the direction of the rotation axis of the deflector 109, passes through one of aperture stops 103 arranged in a line in the direction of the rotation axis of the deflector 109 and then reaches the first lens 105. The first lens 105 and the second lens 107 focus the light beam on one of the side faces of the deflector 109 in the cross section shown in FIG. 2.

FIG. 3 shows a cross section of the imaging optical system, the cross section being parallel to the x-axis and perpendicular to the y-axis. In the case that a deflected light beam travels in the direction perpendicular to the y-axis in the cross section shown in FIG. 1, a point at which the principal ray of the deflected light beam is reflected on a side of the deflector is referred to as a reference point P. The cross section shown in FIG. 1 and that shown in FIG. 3 contain the reference point P. A z-axis of the imaging optical system is defined to agree with the straight line that passes through the reference point P and is perpendicular to the y-axis in the cross section shown in FIG. 1. The cross section shown in FIG. 1 is a cross section that contains the z-axis of the imaging optical system and is perpendicular to the x-axis. The cross section shown in FIG. 3 is a cross section that contains the z-axis of the imaging optical system and is parallel to the x-axis. In the cross section shown in FIG. 3, the light beam reflected at the point P reaches the first scanning lens 111 as a divergent light beam. The first scanning lens 111 converges the light beam in the cross section shown in FIG. 3 such that the light beam serves as a beam for scanning after having passed through the second scanning lens 113.

An example of the present invention will be described below.

### EXAMPLE

Table 1 shows numerical data of an optical scanning system of Example.

TABLE 1

| Item | | Unit | |
|---|---|---|---|
| Effective swath width | | mm | 220 |
| Angle of incidence | Main | deg. | 55 |
| | Sub | deg. | Inside beam 1.0 |
| | | | Outside beam 4.8 |
| System focal length | | mm | 262.6 |
| Light source | Wavelength | nm | 785 |
| | θ⊥ | deg. | 27.5 |
| | θ// | deg. | 9.5 |
| Collimator lens | Focal length | mm | 10 |
| | Center | mm | 3 |
| | thickness | | |
| Aperture | Main | mm | 3 |
| (rectangular shape) | Sub | mm | 1.26 |
| First lens | Center | mm | 3 |
| | thickness | | |
| | Refractive | — | 1.529 |
| | index | | |
| Second lens | Center | mm | 3 |
| | thickness | | |
| | Refractive | — | 1.511 |
| | index | | |
| Polygon mirror | Number of | — | 12 |
| (deflector) | faces | | |
| | Size | mm | Inscribed circle ϕ20 |
| First scanning lens | Center | mm | 7 |
| | thickness | | |
| | Refractive | — | 1.503 |
| | index | | |
| Second scanning lens | Center | mm | 5 |
| | thickness | | |
| | Refractive | — | 1.485 |
| | index | | |

In Table 1, “Angle of incidence (Main)” means an angle that a straight line that is a projection of the path of the principal ray that is incident on a side face of the deflector onto the cross section shown in FIG. 1 forms with the z-axis of the imaging optical system.

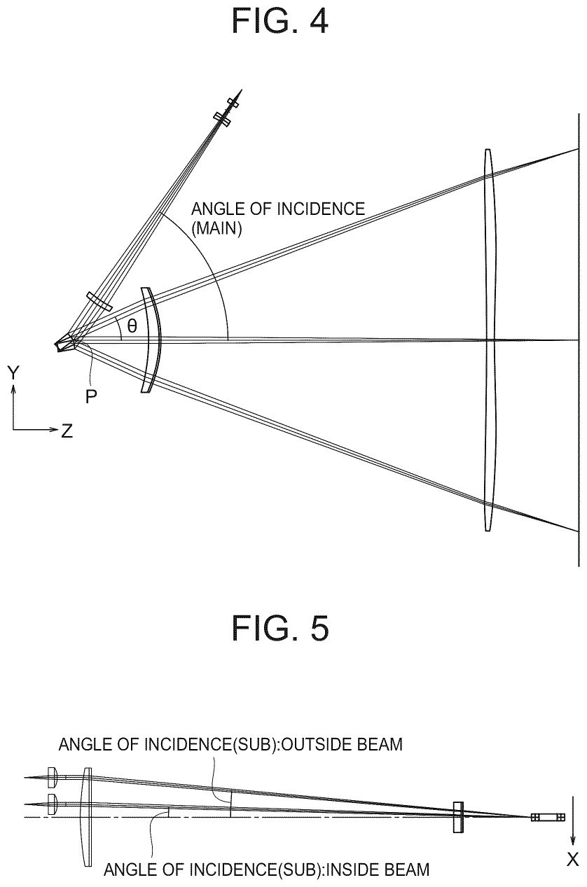

FIG. 4 illustrates “Angle of incidence (Main)”.

In Table 1, “Angle of incidence (Sub)” means an angle that a straight line that is a projection of the path of the principal ray that is incident on a side face of the deflector onto the cross section shown in FIG. 2 forms with the z-axis of the optical system for receiving light.

FIG. 5 illustrates “Angle of incidence (Sub)”.

In Table 1, “System focal length” means f in the expression y=f·θ where y represents the maximum image height and θ represents an angle that a straight line that is a projection of the path of a ray that is deflected by the deflector and then reaches the maximum image height y onto the cross section shown in FIG. 1 forms with the z-axis of the imaging optical system. θ described above is shown in FIG. 4.

Each of the light sources 200 is a laser diode light source.

In Table 1, “θ⊥” of each light source represents a divergence angle of the laser diode light source in the cross section shown in FIG. 1 and “θ//” of each light source represents a divergence angle of the laser diode light source in the cross section shown in FIG. 2.

The center thickness of a lens means a thickness along the z-axis of the optical system for receiving light or along the z-axis of the imaging optical system.

Material of the collimator lenses 101 is glass and the refractive index is 1.576. Material of the first lens 105 is poly-cycloolefin-based plastic and material of the second lens 107 is borosilicate crown glass. Material of the first scanning lens 111 is poly-cycloolefin-based plastic and material of the second scanning lens 113 is polymethyl methacrylate.

Length of “Main” of the aperture means the length in the cross section shown in FIG. 1 and length of “Sub” of the aperture means the length in the cross section shown in FIG. 2.

Table 2 shows distances between two elements and other numerical data of the optical scanning system of Example.

TABLE 2

| | | Inside | Outside |
|---|---|---|---|
| Item | Unit | beam | beam |
| Light source⁻ | mm | 8.17 | 8.17 |
| Entrance surface of collimator lens: L1 | | | |
| Sub-shift | mm | 4.3 | 13 |
| (Light source, collimator lens, aperture) | | | |
| Exit surface of collimator lens ⁻ | mm | 164 | 164 |
| Reference point: L2 | | | |
| Aperture ⁻ | mm | 161 | 161 |
| Reference point: L3 | | | |
| Exit surface of first lens ⁻ | mm | 153 | 153 |
| Reference point: L4 | | | |
| Exit surface of second lens ⁻ | mm | 25 | 25 |
| Reference point: L5 | | | |
| Reference point ⁻ | mm | 45 | 45 |
| Entrance surface of first | | | |
| scanning lens: L6 | | | |
| Reference point ⁻ | mm | 245 | 245 |
| Entrance surface of second | | | |
| scanning lens: L7 | | | |
| Reference point ⁻ | mm | 300 | 300 |
| Scanning plane: L8 | | | |
| Sub-shift | mm | ±3.569 | ±10.89 |
| Second scanning lens | | | |
| Main-shift | mm | −0.482 | −0.482 |
| Second scanning lens | | | |

In Table 2, a distance means a distance along the z-axis of the optical system for receiving light or along the z-axis of the imaging optical system.

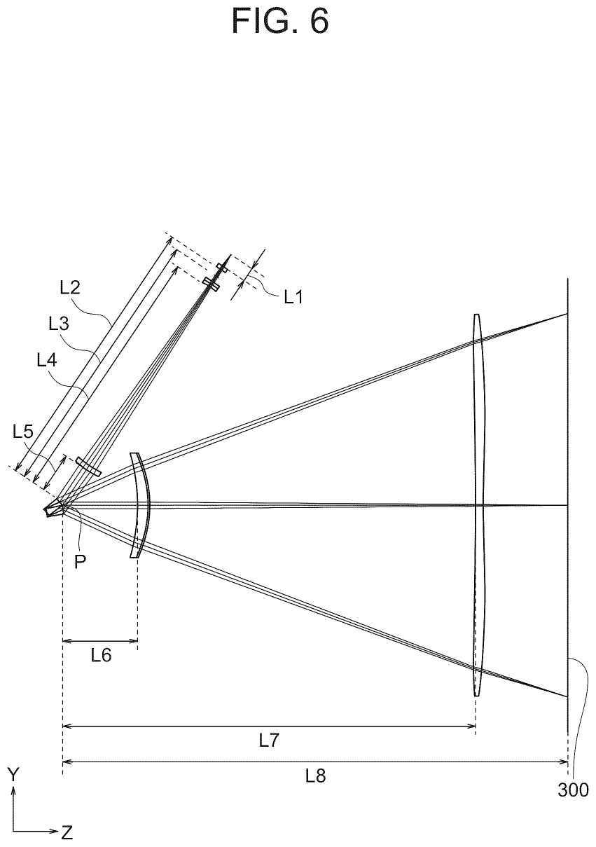

FIG. 6 illustrates distances L1-L8 between two elements given in Table 2. The cross section shown in Table 6 is identical with that shown in Table 1.

In Table 2, “Sub-shift (Light source, collimator lens, aperture)” means a distance between the center of each element and the z-axis of the optical system for receiving light in the cross section shown in FIG. 2.

In Table 2, “Scanning plane” is a plane on which a light beam for scanning is focused and which is perpendicular to the z-axis of the imaging optical system. In FIG. 6, the scanning plane is marked with 300. Scanning in the y-axis direction is carried out on the scanning plane.

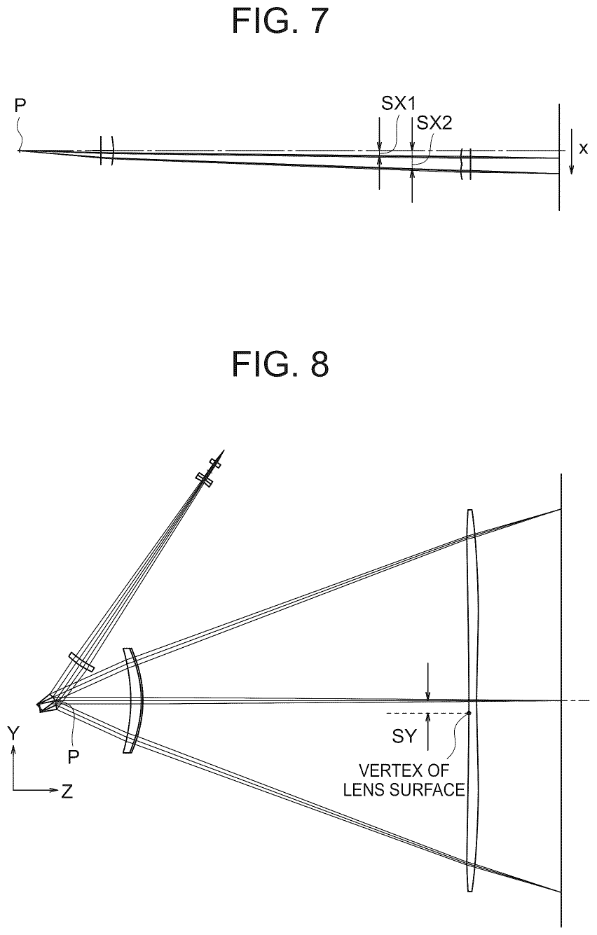

FIG. 7 illustrates “Sub-shift” of the second scanning lens in Table 2. The cross section shown in FIG. 7 is defined in the same way as the cross section shown in FIG. 3 is defined. In Example, the second scanning lens includes 4 lenses that are identical in the shape and arranged adjoiningly in a line in the x-axis direction. Each lens has an entrance surface and an exit surface. The “Sub-shift” of the second scanning lens is a distance between the center of the entrance surface or the exit surface of each lens and the z-axis of the imaging optical system in the cross section shown in FIG. 7. FIG. 7 shows two lenses alone, “Sub-shift” of each of which is positive. In FIG. 7, an absolute value of “Sub-shift” of the inside lens is represented by SX1 and an absolute value of “Sub-shift” of the outside lens is represented by SX2.

FIG. 8 illustrates “Main-shift” of the second scanning lens in Table 2. The cross section shown in FIG. 8 is defined in the same way as the cross section shown in FIG. 1 is defined. The “Main-shift” of the second scanning lens is a distance between the vertex of the entrance surface or the vertex of the exit surface of the second scanning lens and the z-axis of the imaging optical system in the cross section shown in FIG. 8. In FIG. 8, “Main-shift” is represented by SY. In FIG. 8, the distance of SY is made greater than the actual one for an easy understanding.

Each collimator lens 101 in the optical system for receiving light collimates a light beam emitted by one of the light sources 200. The focal length of each collimator lens 101 is 10 millimeters and therefore Expression (1) is satisfied.

$$fcol ≦ 13 \qquad ( 1 )$$

Each surface of each collimator lens 101 will be described below. Each surface of each collimator lens 101 is expressed by the following expression.

$$z = \frac{{r}^{2} / R}{1 + \sqrt{1 - ( 1 + k ) {r}^{2} / {R}^{2}}} + {\sum }_{i = 4}^{N} {A}_{i} {r}^{i}$$

z represents sag of a lens surface, that is, coordinate in the direction of the z-axis of the optical system for receiving light of a point on the lens surface with respect to the vertex of the lens surface. r represents distance between the point on the lens surface and the z-axis. R represents radius of curvature, k represents a conic constant and Ai represents an aspherical coefficient. In the expression described above and the following expressions, the radius of curvature R is defined such that it is positive in the case that the lens surface is convex toward the object and negative in the case that the lens surface is convex toward the image.

Table 3 shows constants and coefficients of each surface of each collimator lens 101.

TABLE 3

| | Collimator lens | |
|---|---|---|
| | Entrance surface | Exit surface |
| R [mm] | 120.167 | −6.000 |
| k | 0 | −1.830 |
| A4 | 0 | −7.037E−04 |
| A6 | 0 | 4.725E−06 |

Each surface of the first lens 105 and the second lens 107 in the optical system for receiving light will be described below.

Table 4 gives description of the shape of each surface of the first lens 105 and the second lens 107. R represents radius of curvature.

TABLE 4

| | Lens surface | Cross section | R [mm] |
|---|---|---|---|
| First lens | Entrance surface | Cross section shown | ∞ |
| | | in FIG. 1 | |
| | | Cross section shown | 82.598 |
| | | in FIG. 2 | |
| | Exit surface | Cross section shown | 18.988 |
| | | in FIG. 1 | |
| | | Cross section shown | ∞ |
| | | in FIG. 2 | |
| Second lens | Entrance surface | Cross section shown | ∞ |
| | | in FIG. 1 | |
| | | Cross section shown | ∞ |
| | | in FIG. 2 | |
| | Exit surface | Cross section shown | −69.148 |
| | | in FIG. 1 | |
| | | Cross section shown | ∞ |
| | | in FIG. 2 | |

The curvature of the entrance surface of the first lens 105 in the cross section shown in FIG. 1 is 0 and the curvature of the entrance surface of the first lens 105 in the cross section shown in FIG. 2 is positive. The entrance surface of the first lens 105 is a cylindrical surface, the curvature of which in the cross section shown in FIG. 2 is positive (that is, the cylindrical surface is convex toward the object). The curvature of the exit surface of the first lens 105 in the cross section shown in FIG. 1 is positive and the curvature of the exit surface of the first lens 105 in the cross section shown in FIG. 2 is 0. The exit surface of the first lens 105 is a cylindrical surface, the curvature of which in the cross section shown in FIG. 1 is positive (that is, the cylindrical surface is convex toward the object).

The curvature of the entrance surface of the second lens 107 in each of the cross section shown in FIG. 1 and the cross section shown in FIG. 2 is 0. The entrance surface of the second lens 107 is a flat surface. The curvature of the exit surface of the second lens 107 in the cross section shown in FIG. 1 is negative and the curvature of the exit surface of the second lens 107 in the cross section shown in FIG. 2 is 0. The exit surface of the second lens 107 is a cylindrical surface, the curvature of which in the cross section shown in FIG. 1 is negative (that is, the cylindrical surface is convex toward the image).

In the first lens 105 and the second lens 107, a toric surface can be used in place of a cylindrical surface.

Table 5 shows absolute value of a focal length in each of the cross section shown in FIG. 1 and the cross section shown in FIG. 2 of each of the first lens 105 and the second lens 107.

TABLE 5

| | Cross section | Focal length [mm] |
|---|---|---|
| First lens | Cross section shown | f11 = 35.876 |
| | in FIG. 1 | |
| | Cross section shown | f12 = 156.1 |
| | in FIG. 2 | |
| Second lens | Cross section shown | f21 = 135.299 |
| | in FIG. 1 | |
| | Cross section shown | f22: ∞ |
| | in FIG. 2 | |

When a ratio of the absolute value of the focal length f21 in the cross section shown in FIG. 1 of the second lens 107 to the absolute value of the focal length f11 in the cross section shown in FIG. 1 of the first lens 105 is represented by M, M=f21/f11=3.77. Accordingly, Expressions (2) and (3) are satisfied.

$$120 ≦ f 12 ≦ 160 \qquad ( 2 )$$

$$3.5 ≦ f 21 / f 11 ≦ 4. \qquad ( 3 )$$

Table 6 shows a ratio of effective diameter D11 of the surface facing the deflector of the first lens to the absolute value of the focal length f11 in the cross section shown in FIG. 1 of the first lens 105 and a ratio of effective diameter D12 of the surface facing the light sources of the first lens to the absolute value of the focal length f12 in the cross section shown in FIG. 2 of the first lens 105.

TABLE 6

| | Example |
|---|---|
| D11 | 1.966 |
| [mm] | |
| f11 [mm] | 35.876 |
| D12 | 1.260 |
| [mm] | |
| f12 [mm] | 156.1 |
| D11/f11 | 0.055 |
| D12/f12 | 0.0081 |

In general, the following expressions should preferably be satisfied concerning D11/f11 and D12/f12.

$$0.04 ≦ D 11 / f 11 ≦ 0 \text{.07} \qquad ( 6 )$$

$$0. 7 ≦ D 12 / f 12 ≦ 0.011 \qquad ( 7 )$$

Temperature of the first lens 105 varies greatly with time under influence of the light sources 200 located nearby. According to the findings of the inventors, however, when D11/f11 is equal to or less than the upper limit of Expression (6) and D12/f12 is equal to or less than the upper limit of Expression (7), deterioration in optical performance of the first lens made of plastic due to a change in refractive index and the like caused by a change in temperature is tolerable. Accordingly, the first lens that has two surfaces, in each of which the shape in a first cross section and the shape in a second cross section is different from each other, can be satisfactorily used. The first cross section is a cross section shown in FIG. 1, that is, a cross section that is perpendicular to the rotation axis of the deflector and contains a common optical axis of the first lens and the second lens. The second cross section is a cross section shown in FIG. 2, that is, a cross section that is parallel to the rotation axis of the deflector and contains the common optical axis of the first lens and the second lens. On the other hand, when D11/f11 is less than the lower limit of Expression (6) or D12/f12 is less than the lower limit of Expression (7), the size of the optical scanning system is too great.

Table 7 shows values of diameter of the light beam in the cross section shown in FIG. 1.

TABLE 7

| Item | |
|---|---|
| Diameter of light beam before received by | 1.97 [mm] |
| first lens (Diameter 1 of light beam) | |
| Diameter of light beam after delivered by second | 8.94 [mm] |
| lens (Diameter 2 of light beam) | |
| Diameter 2/Diameter 1 | 4.54 |

In the cross section shown in FIG. 1, the first lens 105 diverges the collimated light beam and the second lens 107 collimates the diverged light beam.

Concerning the polygon mirror 109, the shape in the cross section shown in FIG. 1 is a regular dodecagon. The diameter of the inscribed circle of the dodecagon is 20 millimeters. The length of a side face of the polygon mirror in the cross section shown in FIG. 1 is as below.

$$2 \cdot 10 \cdot tan ( 15 ° ) = 5.36 [ mm ]$$

Accordingly, the diameter of the light beam that has passed through the second lens 107 and reaches the polygon mirror 109 is greater than the length of a side face of the polygon mirror in the cross section shown in FIG. 1.

Each surface of the first scanning lens 111 and the second scanning lens 113 will be described below. The shape of each surface of the first scanning lens 111 and the second scanning lens 113 is expressed by the following expression.

$$z = \frac{{r}^{2} / R}{1 + \sqrt{1 - ( 1 + k ) {r}^{2} / {R}^{2}}} + {\sum }_{j = 0}^{M} {\sum }_{i = 0}^{N} {A}_{i j} \cdot {x}^{i} {y}^{j}$$

z represents sag of a lens surface, that is, coordinate in the direction of the z-axis of the imaging optical system of a point on the lens surface with respect to the vertex of the lens surface. x represents coordinate in an x-axis direction with respect to the vertex of the lens surface and y represents coordinate in a y-axis direction with respect to the vertex of the lens surface. r represents distance between the point on the lens surface and the z-axis. R represents radius of curvature, k represents a conic constant and Aij represents an aspherical coefficient. The following expression holds.

$$r = \sqrt{{x}^{2} + {y}^{2}}$$

Table 8 shows constants and coefficients of each surface of the first scanning lens 111 and the second scanning lens 113.

TABLE 8

| | First scanning lens | | Second scanning lens | |
|---|---|---|---|---|
| | Entrance | Exit | Entrance | Exit |
| | surface | surface | surface | surface |
| R | ∞ | ∞ | ∞ | ∞ |
| k | 0 | 0 | 0 | 0 |
| A20 | −2.70E−03 | −1.39E−02 | 2.19E−02 | −7.58E−04 |
| A02 | −4.58E−03 | −7.21E−03 | −1.43E−05 | 4.69E−04 |
| A40 | 0 | 0 | 0 | 0 |
| A22 | 8.52E−07 | 3.30E−07 | −8.62E−07 | −6.89E−07 |
| A04 | −3.29E−07 | −4.76E−07 | −2.79E−08 | −9.18E−08 |
| A60 | 0 | 0 | 0 | 0 |
| A42 | 0 | 0 | 0 | 0 |
| A24 | 0 | 0 | 0 | 0 |
| A06 | −2.70E−11 | −1.14E−10 | 2.11E−12 | 2.73E−12 |

Table 9 shows numerical data of the imaging optical system.

TABLE 9

| | Unit | |
|---|---|---|
| BF | mm | 50 |
| L8 | mm | 300 |
| BF/L8 | — | 0.17 |
| B | — | 0.39 |

BF represents a distance between the vertex of the exit surface of the second scanning lens 113 and the scanning plane 300. As described above, L8 represents a distance along the z-axis of the imaging optical system between the reference point and the scanning plane 300. β represents a lateral magnification of the imaging optical system in the cross section shown in FIG. 2. Accordingly, Expression (4) and (5) are satisfied.

$$0.15 ≦ BF / L 8 ≦ 0.2 \qquad ( 4 )$$

$$0.35 ≦ β ≦ 0. 45 \qquad ( 5 )$$

What is claimed is:

1. An optical scanning system comprising a deflector, collimator lenses arranged in a line in the direction of the rotation axis of the deflector, a first lens, a second lens and an imaging optical system,
wherein the optical scanning system is configured such that a light beam that has passed through one of the collimator lenses, the first lens and the second lens and is deflected by the deflector is converged by the imaging optical system such that the light beam serves as a beam for scanning and
wherein when a cross section that is perpendicular to the rotation axis and contains a common optical axis of the first lens and the second lens is referred to a first cross section and a cross section that is parallel to the rotation axis and contains the optical axis is referred to a second cross section, in both lens surfaces of the first lens and one lens surface of the second lens, the shape in the first cross section and the shape in the second cross section is different from each other, a surface facing the second lens of the first lens is shaped in the first cross section to diverge a light beam, a surface facing the collimator lenses of the first lens is shaped in the second cross section to converge a light beam and a surface of the second lens is shaped in the first cross section to collimate or converge a light beam and
wherein the optical scanning system is configured such that a width of a light beam that has reached a side face of the deflector is greater than a length of the side face in the first cross section and the light beam is focused on the side face in the second cross section.

2. The optical scanning system according to claim 1, wherein both surfaces of the first lens and one surface of the second surface is cylindrical or toric.

3. The optical scanning system according to claim 1, wherein material of the first lens is plastic and the material of the second lens is glass.

4. The optical scanning system according to claim 1, wherein when a value of focal length of each of the collimator lenses is represented by fcol [mm], an absolute value of focal length in the first cross section of the first lens is represented by f11 [mm], an absolute value of focal length in the second cross section of the first lens is represented by f12 [mm] and an absolute value of focal length in the first cross section of the second lens is represented by f21 [mm], the following expressions are satisfied.
$$fcol ≦ 13 \qquad ( 1 )$$
$$120 ≦ f 12 ≦ 160 \qquad ( 2 )$$
$$3.5 ≦ f 21 / f 11 ≦ 4. . \qquad ( 3 )$$

5. The optical scanning system according to claim 1, wherein when a first straight line that is a projection of a path of the principal ray of a deflected light beam onto a plane perpendicular to the rotation axis of the deflector is perpendicular to a second straight line that is a projection of the scanning direction onto the plane, a point at which the principal ray is reflected on the deflector is referred to as a reference point, a distance between the reference point and a scanning plane on which a beam for scanning is focused and which is perpendicular to the first straight line is represented by L8, a distance between the vertex of a lens surface that is closest to the scanning plane and the scanning plane is represented by BF, a plane that contains the reference point and is parallel to the rotation axis and the first straight is referred to as a third cross section, and a lateral magnification of the imaging optical system in the third cross section is represented by β, the following expressions are satisfied.
$$0.15 ≦ BF / L 8 ≦ 0.2 \qquad ( 4 )$$
$$0.35 ≦ β ≦ 0.45 . \qquad ( 5 )$$

6. The optical scanning system according to claim 1, wherein material of the first lens is plastic and when an effective diameter of the surface facing the second lens of the first lens is represented by D11, an absolute value of focal length in the first cross section of the first lens is represented by f11, an effective diameter of the surface facing the collimator lenses of the first lens is represented by D12 and an absolute value of focal length in the second section of the first lens is represented by f12, the following expressions are satisfied.
$$0.04 ≦ D 11 / f 11 ≦ 0 \text{.07} \qquad ( 6 )$$
$$0. 7 ≦ D 12 / f 12 ≦ 0.0 11. \qquad ( 7 )$$

7. An optical scanning system comprising a deflector, collimator lenses arranged in a line in the direction of the rotation axis of the deflector, a first lens, a second lens and an imaging optical system,
wherein the optical scanning system is configured such that a light beam that has passed through one of the collimator lenses, the first lens and the second lens and is deflected by the deflector is converged by the imaging optical system such that the light beam serves as a beam for scanning and
wherein when a cross section that is perpendicular to the rotation axis and contains a common optical axis of the first lens and the second lens is referred to a first cross section and a cross section that is parallel to the rotation axis and contains the optical axis is referred to a second cross section, in both lens surfaces of the first lens and one lens surface of the second lens, the shape in the first cross section and the shape in the second cross section is different from each other, one surface of the first lens is shaped in the first cross section to diverge a light beam, the other surface of the first lens is shaped in the second cross section to converge a light beam and a surface of the second lens is shaped in the first cross section to collimate or converge a light beam,
wherein the optical scanning system is configured such that a width of a light beam that has reached a side face of the deflector is greater than a length of the side face in the first cross section and the light beam is focused on the side face in the second cross section and
wherein when a first straight line that is a projection of a path of the principal ray of a deflected light beam onto a plane perpendicular to the rotation axis of the deflector is perpendicular to a second straight line that is a projection of the scanning direction onto the plane, a point at which the principal ray is reflected on the deflector is referred to as a reference point, a distance between the reference point and a scanning plane on which a beam for scanning is focused and which is perpendicular to the first straight line is represented by L8, a distance between the vertex of a lens surface that is closest to the scanning plane and the scanning plane is represented by BF, a plane that contains the reference point and is parallel to the rotation axis and the first straight is referred to as a third cross section, and a lateral magnification of the imaging optical system in the third cross section is represented by β, the following expressions are satisfied.
$$0.15 ≦ BF / L 8 ≦ 0.2 \qquad ( 4 )$$
$$0.35 ≦ β ≦ 0.45 . \qquad ( 5 )$$

8. An optical scanning system comprising a deflector, collimator lenses arranged in a line in the direction of the rotation axis of the deflector, a first lens, a second lens and an imaging optical system,
wherein the optical scanning system is configured such that a light beam that has passed through one of the collimator lenses, the first lens and the second lens and is deflected by the deflector is converged by the imaging optical system such that the light beam serves as a beam for scanning and
wherein when a cross section that is perpendicular to the rotation axis and contains a common optical axis of the first lens and the second lens is referred to a first cross section and a cross section that is parallel to the rotation axis and contains the optical axis is referred to a second cross section, in both lens surfaces of the first lens and one lens surface of the second lens, the shape in the first cross section and the shape in the second cross section is different from each other, one surface of the first lens is shaped in the first cross section to diverge a light beam, the other surface of the first lens is shaped in the second cross section to converge a light beam and a surface of the second lens is shaped in the first cross section to collimate or converge a light beam,
wherein the optical scanning system is configured such that a width of a light beam that has reached a side face of the deflector is greater than a length of the side face in the first cross section and the light beam is focused on the side face in the second cross section and
wherein material of the first lens is plastic and when an effective diameter of the one surface of the first lens is represented by D11, an absolute value of focal length in the first cross section of the first lens is represented by f11, an effective diameter of the other surface of the first lens is represented by D12 and an absolute value of focal length in the second section of the first lens is represented by f12, the following expressions are satisfied.
$$0.04 ≦ D 11 / f 11 ≦ 0 \text{.07} \qquad ( 6 )$$
$$0. 7 ≦ D 12 / f 12 ≦ 0.0 11. \qquad ( 7 )$$
